(19) United States
(12) Patent Application Publication
(10) Pub. No.: US 2015/0154632 A1
(43) Pub. Date: Jun. 4, 2015

(54) Determining a number of view-through conversions for an online advertising campaign

(71) Applicants: Deepak Jindal, San Francisco, CA (US); Gokul Rajaram, Los Altos, CA (US); Rama Ranganath, San Francisco, CA (US); Fong Shen, San Jose, CA (US)

(72) Inventors: Deepak Jindal, San Francisco, CA (US); Gokul Rajaram, Los Altos, CA (US); Rama Ranganath, San Francisco, CA (US); Fong Shen, San Jose, CA (US)

(21) Appl. No.: 11/799,327

(22) Filed: Apr. 30, 2007

(51) Int. Cl. G06Q 30/02; G06F 15/16

(52) U.S. Cl. CPC G06Q 30/0246; G06Q 30/0277

(57) ABSTRACT

Embodiments consistent with the present invention may be used to provide accurate view-through conversion information, even in the absence of impression cookies. A view-through conversion occurs when, first, a user is exposed to an online ad (also known as an impression event), but does not select (e.g., click on) it, but the user later visits the advertiser's Website and a “conversion” occurs within a certain period (e.g., a 30-day period).

### §1. BACKGROUND OF THE INVENTION

§1.1 Field of the Invention

The present invention concerns online advertising. In particular, the present invention concerns determining the number of view-through conversions an advertiser's webpage has incurred within a predetermined time window (e.g., 30 days) after users have been exposed to an ad campaign.

§1.2 Background Information

View-through conversion is an important metric for brand advertisers. It may be used to help them to determine the effectiveness of their advertising campaigns.

View-through conversion measures the effects of a campaign exposure to a user's post impression activity on advertiser's Website. A view-through conversion occurs when, first, a user is exposed to an online ad (also known as an impression event), but does not select (e.g., click on) it (i.e., ‘view’ only), and the user later visits the advertiser's Website and a “conversion” occurs within a certain period (usually a 30-day period).

There is some technical difficulty in tracking view-through conversions though, particularly if impression ads do not have cookies. For example, in at least one ad serving system, when an impression request is made, the user (proxy) IP address is logged into an “Ad Query” log. Therefore, IP addresses might be used to track users that have seen an impression ad. Whether they had a conversion might be determined by checking against the IP addresses that had a conversion event on the advertiser's Website. There are some limitations with IP address-based conversion tracking though. First, one user may have multiple IP addresses due to dynamic IP address assignment, or due to a user getting online from various locations (e.g. home, office, etc.). Thus the IP address that has been exposed to a campaign might not be the same IP address that had a conversion event on the advertiser's Website, even though the requests came from the same user. Second one IP address may have many users behind it, such as through a proxy or with shared computer. In this case, it is hard to track whether the user that viewed the impression ad is the same user that ended up on the advertiser's Website, even though the requests all came from the same IP address.

As can be appreciated from the foregoing, IP address-based conversion tracking is most accurate when there is a single-user associated with a single IP address at all times. U.S. patent application Ser. No. 11/479,154 (referred to as “the '154 application” and incorporated herein by reference in its entirety), titled “ESTIMATING THE NUMBER OF UNIQUE USERS SHARING AN IP ADDRESS,” filed on Jun. 30, 2006 and listing Fong Shen, Deepak Jindal, Rama Ranganath, Gokul Rajaram as inventors, describes IP address-user database that maintains the number of users associated with an IP address over a period of time. The IP address-user database provides IP user estimations based on IP cookie analysis on traffic for a Website. However, not all visitors to the analyzed Website visit site-targeting publishers' Websites.

As can be appreciated from the foregoing, it would be useful to provide accurate view-through conversion information, even in the absence of impression cookies.

### §2. SUMMARY OF THE INVENTION

Embodiments consistent with the present invention may be used to provide accurate view-through conversion information, even in the absence of impression cookies. Some exemplary embodiments consistent with the present invention might determine consumer response to a set of one or more advertisements received by a computer over a network wherein the advertisement is perceived but not immediately selected on, by (a) associating each of one or more computers in a plurality of computers on a network with a computer identifier, (b) tracking impressions of an advertisement from the set of one or more advertisements at a plurality of computers on a network in a time window, in association with the computer identifiers, (c) accepting an estimated a number of computer users associated with each computer identifier, (d) logging conversions from an advertiser location on the network associated with the advertisement in association with the computer identifier, and (e) determining a number of view-through conversions in the time window as a function of (A) a number of the impression tracked in the tracking act, (B) the estimated number of computer users and (C) a number of the conversions logged in the logging act, during the time window.

Some embodiments consistent with the present invention might provide accurate view-through conversion information, even in the absence of impression cookies, by (a) determining single-user Internet Protocol addresses that had a view-through conversion for an advertisement of an advertiser to define a sample set of Internet Protocol addresses, (b) determining a sample view-through conversion rate for the determined sample set of Internet Protocol address, and (c) determining an estimated total number view-through conversions for the advertisement using the sample view-through conversion rate.

Some embodiments consistent with the present invention might estimate a sample view-through conversion rate for an advertising campaign to users on computers associated with one or more Internet Protocol addresses on an Internet Protocol network. Such embodiments might do so by (a) measuring advertising views by Internet Protocol address segment, (b) measuring advertising conversions by Internet Protocol address segment, and (c) matching view-through advertising for single-user Internet Protocol address segments by associating the advertising conversion Internet Protocol address segments and advertising views Internet Protocol address segments with known single-user Internet Protocol addresses and estimating a sample view-through conversion rate therefrom.

Some embodiments consistent with the present invention might measure advertising campaign impressions to computers associated with single user Internet Protocol addresses on an Internet Protocol network. Such embodiments might do so by (a) obtaining a set of distinct Internet Protocol addresses that were exposed to each campaign but did not immediately select an advertisement of the campaign, (b) obtaining a total number of impressions for each campaign, and (c) filtering out multi-user Internet Protocol addresses to get a number of impressions for the single-user Internet Protocol addresses.

### §3. BRIEF DESCRIPTION OF THE DRAWINGS

FIG. 1 is a diagram illustrating an environment in which, or with which, embodiments consistent with the present invention may operate.

FIG. 2 is a bubble diagram of exemplary operations that may be performed in a manner consistent with at least one embodiment of the present invention, as well as information that may be used and/or generated by such operations.

FIG. 3 is a flow diagram of an exemplary method for determining the total number of view-through conversions that result from an advertising campaign, in a manner consistent with at least one embodiment of the present invention.

FIG. 4 is a flow diagram of an exemplary method for determining IP addresses that had a conversion event, in a manner consistent with at least one embodiment of the present invention.

FIG. 5 is a flow diagram of an exemplary method for determining IP addresses exposed to an ad campaign and engaged in a view-through conversion event, in a manner consistent with at least one embodiment of the present invention.

FIG. 6 is a flow diagram of an exemplary method for determining the total number of view-through conversions that result from an advertising campaign, in a manner consistent with at least one embodiment of the present invention

FIG. 7 is a block diagram of an exemplary apparatus that may perform various operations, and store various information generated and/or used by such operations, in a manner consistent with at least one embodiment of the present invention.

### §4. DETAILED DESCRIPTION

The present invention may involve novel methods, apparatus, message formats, and/or data structures for determining the number of view-through conversions that result from an online advertising campaign. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. In the following, “information” may refer to the actual information, or a pointer to, identifier of, or location of such information. Thus, the present invention is not intended to be limited to the embodiments shown and the inventors regard their invention to include any patentable subject matter described.

In the following, terms that are used in this application are defined in §4.1. Then, environments in which, or with which, embodiments consistent with the present invention may operate are described in §4.2. Then, exemplary embodiments consistent with the present invention are described in §4.3. Thereafter, an illustrative example of operations of an exemplary embodiment consistent with the present invention is presented in §4.4. Finally, some conclusions regarding the present invention are set forth in §4.5.

### §4.1 DEFINITIONS

“View” means that a user sees, hears or otherwise perceives a campaign (ad impression), but does not select it.

“Click” means that a user perceives a campaign and also selects it.

“Conversion” means that a user does some activity on an advertiser's site such as registration, sales, visiting a particular page (e.g., specified by the advertiser) or performing another activity (such as, for example, requesting product information, sending a product inquiry, or adding items to a shopping cart) (e.g., specified by the advertiser), and is thus considered to have converted.

A “client identifier” is information that might be used to uniquely identify, or to help to uniquely identify, a client device (e.g., a computer on a network) and/or a user.

A “cookie” is (e.g., textual) information sent by a server to a client device application (e.g., a Web browser on a computer) for storage on (or by) the client device, and then sent back to the server when the client device application later accesses the server. For example, an “HTTP cookie” is a parcel of textual information sent by a server to a Web browser and then sent back by the browser each time it accesses the server. HTTP cookies may be used for user authentication, user tracking, and maintaining user-specific information such as Website preferences, electronic shopping carts, etc.

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. In the case of a video ad, ad features may include video content and, most likely, audio content. The ad features may also include executable code (e.g., encoded as tones, pixels, etc., provided in non-video packets of a video stream, etc.). Depending on the type of online ad, ad features may include one or more of the following: text, a link, an audio file, a video file, an image file, executable code, embedded information, etc. In devices that can render more than one type of media (devices that have different outputs), some ad features may pertain to one type of media rendered to the user over one output, while other ad features may pertain to another type of media rendered to the user over another output. For example, if a mobile telephone includes a speaker, a display and telephony means, a video ad to be rendered on such a telephone can have one or more of an audio-video component and executable code for dialing an encoded telephone number. Ads may also be provided in other forms of display, such as, for example, in printed form, in signage, in broadcast form, or over a media broadcast system. Naturally, other types of ad features are possible.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, an ad spot in which the ad was served (e.g., a position (spatial or temporal) of the ad relative to other ads served), an absolute size of the ad, a size of the ad relative to other ads, an absolute and/or relative resolution of the ad, an absolute and/or relative video frame rate of the ad, an absolute volume of the ad, a volume of the ad relative to other ads, an absolute temporal length of the ad, a relative temporal length of the ad, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document, on which, or with which, the ad is to be served, includes certain topics or concepts, or falls under a particular cluster or clusters, or some other classification or classifications (e.g., verticals). In some systems, an advertiser may specify that its ad is to be served only to (or is not to be served to) user devices having certain characteristics. Finally, in some systems, an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs, dial-throughs, etc.) of an ad to the number of impressions of the ad (i.e., the number of times an ad is rendered) is defined as the “selection rate” (or “clickthrough rate” or “CTR”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, dialing a telephone number, sending a product or service inquiry, etc. Often, if user actions don't indicate a consummated purchase, they may indicate a sales lead, although user actions constituting a conversion are not limited to this. Indeed, many other types of conversion are also possible.

The ratio of the number of conversions to the number of impressions of the ad (i.e., the number of times an ad is rendered) and the ratio of the number of conversions to the number of selections (or the number of some other earlier event) are both referred to as the “conversion rate” or “CR.” The type of conversion rate will be apparent from the context in which it is used. If a conversion is defined to be able to occur within a predetermined time since the serving of an ad, one possible definition of the conversion rate might only consider ads that have been served more than the predetermined time in the past.

A “property” is something on which ads can be presented. A property may include online content (e.g., a Website, a video program, a Webcast, a podcast, online games, etc.), offline content (e.g., a newspaper, a magazine, a theatrical production, a concert, a sports event, a television broadcast, etc.), and/or offline objects (e.g., a billboard, a stadium score board, an outfield wall, the side of truck trailer, etc.). Properties with content (e.g., magazines, newspapers, Websites, email messages, television programs, etc.) may be referred to as “media properties.” Although properties may themselves be offline, pertinent information about a property (e.g., attribute(s), topic(s), concept(s), category(ies), keyword(s), relevancy information, type(s) of ads supported, etc.) may be available online. For example, an outdoor jazz music festival may have entered the topics “music” and “jazz”, the location of the concerts, the time of the concerts, artists scheduled to appear at the festival, and types of available ad spots (e.g., spots in a printed program, spots on a stage, spots on seat backs, audio announcements of sponsors, on site video displays, etc.). A “video property” is a property that can be seen. A video property may include other components (e.g., audio), but not necessarily.

### §4.2 EXEMPLARY ENVIRONMENTS IN WHICH, OR WITH WHICH, EMBODIMENTS CONSISTENT WITH THE PRESENT INVENTION MAY OPERATE

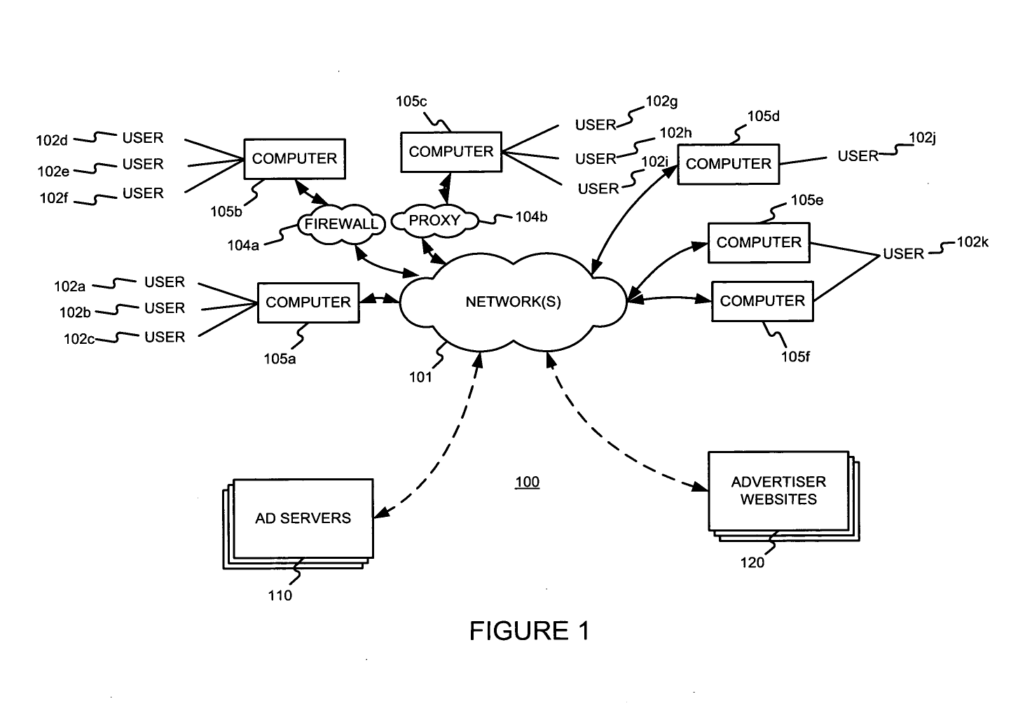

FIG. 1 is a diagram illustrating an exemplary environment 100 in which, or with which, embodiments consistent with the present invention may operate. Specifically, the environment 100 may include one or more network(s) (e.g., the Internet) 101 over which parties or entities such as users 102a-102k, computers 105a-105f, ad servers 110, and advertiser Websites 120 can communicate.

The environment 100 illustrates various ways that users 102a-102k can interact with (e.g., servers on) the network(s), such as those that were addressed in the background section above. Some possible interactions include, for instance, (a) multiple users 102a-102c sharing the same computer 105a, (b) multiple users 102d-102f sharing the same computer 105b through a firewall 104a (or multiple/single users operating on different computers behind a firewall 104a (not shown)), (c) multiple users 102g-102i using the same computer 105c to access the network(s) 101 through a proxy server 104b (or multiple/single users operating on different computers behind a proxy server 104b (not shown)), (d) a single user 102j using a single computer 105d to access the network(s) 101, and (e) a single user 102k using multiple computers 105e and 105f to access the network(s) 101. As the foregoing different examples (and other possible configurations) illustrate, it is challenging to track the exact number of users behind a given IP address. Similarity, it is challenging to identify a given user at different times on the same or different client device.

Other interactions that may occur within the environment 100 are interaction between the users 102a-102k, ad servers 110 and advertiser Websites 120. In particular, certain users may be exposed to advertiser's 120 ad campaigns as these users are browsing through the network(s) 101. For instance, these users 102a-102k may be served ad impressions after an initial request is made to ad server 110 by their browsers following the browsing of certain Websites or search engines. After an exposure to an ad impression, if enabled, a user may select the ad impression which will redirect the user to the advertiser's Website 120. Hence, the user may engage in a click-through conversion. However, it may be possible that a user simply views only the ad impression but later visits the advertiser's Website within a certain period (e.g., 30-day period). In this case the user has engaged in a view-through conversion. The present invention proposes a method for determining such view-through conversions in an environment as illustrated by exemplary environment 100. Advantageously, view-through conversion can be tracked per advertiser, per advertising campaign, per ad group, or through other useful informational segments (e.g., ads served over a particular time periods, ads served to a particular demographic, ads served using a specific combination of one or more advertising criteria such as ads targeted using specific keywords, etc.).

### §4.3 EXEMPLARY EMBODIMENTS

Embodiment consistent with the present invention might determine view-through conversion measurements using, for example, six (6) measurements:
(1) conversions: conversions measure the number of unique users that have view-through conversions;
(2) conversion-rate: conversion rate measures the number of conversions per thousand of impressions for each campaign;
(3) transactions: transactions measure the number of visits on conversion pages (e.g. visiting an advertiser's web site and visiting the advertiser's conversion page) by those users with view-through conversion;
(4) transaction-rate: transaction rate measures the number of transactions per thousand of impressions for each campaign; and
(5) transaction-per-user: measures the average number of transactions per user. It is calculated as total number of transactions divided by conversions for each campaign.
   For instance, if a user was exposed to an ad campaign, and later visited the advertiser's Website three (3) times, although a conversion might be defined to include a Website visit, the forgoing might be considered one (1) conversion and three (3) transactions. Using this example, if an ad campaign has 2000 impressions, 10 unique converted users, and 20 visits to the advertiser's conversion page for a day, the ad campaign has following metrics for the day:

conversions=10

conversion rate=(10/2000)*1000=5

transactions=20

transaction rate=(20/2000)*1000=10

transaction-per-user=20/10=2

View-through conversion reporting may include daily, weekly, monthly, and/or to-date, view-through conversions, as defined below. First, to-date view-through conversions might be determined using: (1) conversions (total conversions since campaign start date); (2) conversion-rate (total conversions per thousand impressions since campaign start date); (3) transactions (total transactions since campaign start date); (4) transaction-rate (total transactions per thousand impressions since campaign start date); and (5) transaction-per-user (average number of transactions per user since campaign start date. Second, daily view-through conversions might be determined using: (1) conversions (the difference of the day and previous day's to-date conversions. This is to de-duplicate the same user that is counted as conversions in previous days. For instance, if today's to-date conversions is 10, yesterday's to-date conversions is 9, and there are 2 conversions today, there must be a user that have converted today and the days before. Therefore today's daily conversions is 10−9=1, and total conversions so far (to-date) is 10.); (2) conversion-rate (conversions per thousand impressions for the day); (3) transactions (similar to the definition of conversions, the difference of the day and previous day's to-date transactions); (4) transaction-rate: transactions per thousand impressions for the day; and (5) transaction-per-user: average number of transactions per user for the day. Third, weekly view-through conversions might be determined using: (1) conversions (total number of daily conversions for the week); (2) conversion-rate (conversions per thousand impressions for the week); (3) transactions (total number of daily transactions for the week); (4) transaction-rate (transactions per thousand impressions for the week); and (5) transaction-per-user (average number of transactions per user for the week). Finally, monthly view-through conversions might be determined using: (1) conversions (total number of daily conversions for the month); (2) conversion-rate (conversions per thousand impressions for the month); (3) transactions (total number of daily transactions for the month); (4) transaction-rate (transactions per thousand impressions for the month); and (5) transaction-per-user (average number of transactions per user for the month). Selection of the appropriate time window can be manual, or it can be variable based on, for example, the approximate time period for a particular ad to obtain a particular number of impressions, the approximate time period for a particular ad to obtain a particular number of conversions, or other informational metrics.

Embodiments consistent with the present invention might provide view-through conversion reporting at various levels such as, for example, (a) campaign level (provide view-through conversion reporting on a per-campaign basis), (b) ad group level (provide view-through conversion reporting on a per ad group, per campaign basis), and/or (c) site-level (for site-targeting campaigns, provide view-through conversion reporting on a per site, per campaign basis (i.e. view-through numbers for each campaign on each site).

In general, clicks are weighted as a more influential factor for conversion than views. Therefore, in some embodiments consistent with the present invention, if a user has both clicks and views on an ad campaign, and later converts, the present invention attributes the conversion as a click-through conversion (not a view-through conversion) as long as the click event is within the conversion window (default is 30 days, although this window can be other time ranges). Preferably in one such embodiment, this exemplary counting method does not perform double counting a conversion as both a click-through and view-through conversion. Therefore, when counting view-through conversions, conversions that have clicks on the ad campaign are excluded. In other words, once a click happens, all conversions after the click within the conversion time window are considered click-through conversions, but not view-through conversions. The following scenarios help clarify the exemplary counting method:

### Scenario 1

Suppose the sequence of events for a user is as follows: view-click-view-conversion, and all the events happen within the conversion window (normally 30 days). In this case, since the user has clicked on the campaign first, the conversion is considered as a result of user clicking on the campaign. Consequently, it is counted as a click-through conversion, not a view-through conversion.

### Scenario 2

Suppose the sequence of events for a user is as follows: click-conversion-view-conversion, and all the events happen within the conversion time window (normally 30 days). In this case, the 1st conversion is obviously considered a click-through conversion. However, the 2nd conversion is also considered as a click-through conversion, since the conversion is still within the click-through conversion time window.

### Scenario 3

Suppose the sequence of events for a user is as follows: view-conversion-click-conversion, and all the events happen within the conversion time window (normally 30 days). In this case, the 1st conversion is considered as a view-through conversion, as the click has not happened yet. The 2nd conversion is considered as a click-through conversion.

### Scenario 4

Suppose the sequence of events for a user is as follows: click (day 1)—view (day 2)—conversion (day 30)—view (day 31)—conversion (day 32), and the conversion time window for both view-through and click-through are 30 days. In this case, the 1st conversion is considered as a click-through conversion as it falls within the click-through conversion time window. The 2nd conversion is considered as a view-through conversion since it has passed the click-through conversion time window.

### Scenario 5

Suppose the sequence of events for a user is as follows: click (day 1)—view (day 20)—conversion (day 21), the click-through conversion time window is 30 days, and view-through conversion time window is 7 days. In this case, the conversion is still considered as a click-through conversion, since the conversion happens within the click-through conversion time window.

View-through conversions might be tracked per advertiser (customer). Therefore, if an advertiser has multiple ad campaigns running, all of which have the same ad landing page, a conversion may be the result of exposure to one or several of these campaigns. The general industrial practice is to credit the latest exposed ad campaign for view-through conversion counting. At some embodiments consistent with the present invention might follow this practice. In (i.e., views) granularity of some embodiments consistent with the present invention, ad campaign exposure time is by day. If a user is exposed to multiple campaigns by the same advertiser on a single day and later converts, some embodiments might randomly pick one of the ad campaigns and credit it with view-through conversion since the granularity causes a tie as far as which ad campaign was most recently viewed.

The same practice might be used for crediting a Website or ad group for view-through conversions. For example if a user is exposed to the same campaign through multiple Websites/ad-groups and later converts, the Website or ad-group that has the user's latest exposure event gets credited for view-through conversion for the campaign. The following scenarios help clarify how an ad campaign is credited for view-throughs in such embodiments.

### Scenario 1

Suppose an advertiser has two (2) ad campaigns running during the month of January. A user is exposed to ad campaign 1 on January 1 and ad campaign 2 on January 2. The same user later converts on the advertiser's Website on January 30. Assuming the view-through conversion time window is 30 days, going back 30 days, ad campaign 2 is the latest exposed ad campaign. Consequently, ad campaign 2 gets credited for a view-through conversion.

### Scenario 2

Suppose an advertiser has two (2) ad campaigns running during the month of January. A user is exposed to both ad campaign 1 and ad campaign 2 on January 1. The same user later converts on the advertiser's Website on January 30. Assume the view-through conversion time window is 30 days and view tracking granularity is one (1) day. Since both ad campaigns are exposed on the same day, one of the ad campaigns is randomly chosen and credited with a view-through conversion.

### Scenario 3

Suppose an advertiser has one (1) ad campaign running on two 2 Websites during the month of January. A user is exposed to the ad campaign through Website 1 on January 1, and through Website 2 on January 2. The same user later converts on the advertiser's Website on January 30th. Assume the view-through conversion time window is 30 days. Since the latest exposure to the ad campaign is through Website 2, Website 2 gets credited for view-through conversion on the ad campaign.

Alternatively, if a user is exposed to multiple campaigns by the same advertiser within the time window and then converts, the credit may be distributed between the advertiser's campaigns with weighting towards the campaigns closer in time to the conversion.

Embodiments consistent with the present invention determine view-through conversion information based on view-through conversions of IP addresses, typically those associated with a single-user. Single-user IP addresses are used as a sampling group to measure a sample view-through conversion rate. The sample view-through conversion rate is then used for all IP addresses that are exposed to an ad campaign.

A sample view-through conversion rate for an advertising campaign for single user IP addresses might be determined by (1) measuring impressions by IP segment (e.g., an IP address, ranges of IP addresses, subnets, and the like), (2) measuring conversions by IP segment, and (3) matching view-through conversions for single-user IP segment.

Impressions might be measured by IP segment by (1) obtaining the set of distinct IP addresses that were exposed to each campaign but not clicked, (2) obtaining the number of impressions for each campaign, and (3) filtering out multi-user IP addresses to get the number of IPs and impressions in single-user IP segment.

Conversions might be measured by IP segment by (1) obtaining the set of distinct IP addresses that had a conversion event on the advertiser's Website, (2) obtaining the number of conversions associated with each IP on the advertiser's Website, and (3) filtering out multi-user IP addresses to get the number of IPs and conversions in single-user IP segment.

Finally, matching view-through conversions for single user IP segments might be performed by (1) determining, for each IP address that had a conversion event, whether it was exposed to an ad campaign, and (2) associating the conversion event with the most recently exposed ad campaign.

Sample view-through conversion rates might be determined by determining the view-through conversion rate for single-user IP segment by number of conversions per thousand impressions. Then, the conversion rate from single-user IP segment might be used to get total number of view-through conversions for each campaign.

View-through conversion determinations performed in a manner consistent with the present invention might be used for Website-targeting ad campaigns, content-based ad campaigns, and/or search-based ad campaigns.

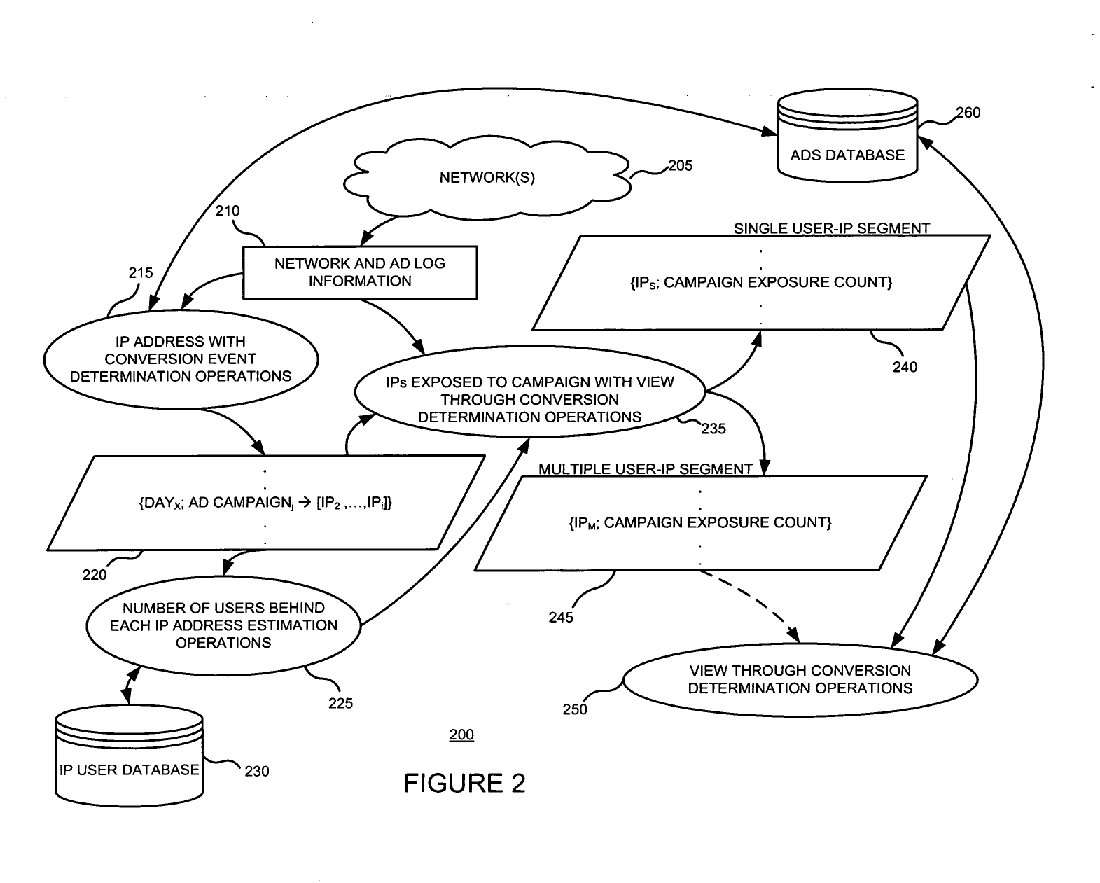

FIG. 2 is a bubble diagram of exemplary operations that may be performed in a manner consistent with the present invention, as well as information that may be used and/or generated by such operations. The system 200 might include IP address with conversion event determination operations 215, number of users behind each IP address estimation operations 225, IP addresses exposed to campaign with view-though conversion determination operations 235, and view-through conversion determination operations 250.

Network and ad log information 110 obtained from network(s) 205 may be available to the IP address with conversion event determination operations 215, as well as the IP addresses exposed to campaign with view-through conversion determination operations 235. Using such network and ad log information 210, the IP address with conversion event determination operations 215 may determine (e.g., on a daily basis) the number of IP addresses with a conversion event for a specific ad campaign. So the output format of the IP address with conversion event determination operations might be IP addresses per campaign, per day: {Dayₓ; Ad Campaignⱼ→[IP₁, . . . , IPᵢ]} 220. Although this example is shown for one day granularity, other smaller (or larger) time windows are also possible. This output may be available to the number of users behind each IP address estimation operations 225, as well as to the IP addresses exposed to campaign with view-through conversion determination operations 235. Using network and ad log information 210, in addition to IP user database information 230, the operations 225 may determine the number of users behind each of the outputted IP addresses 220 considered by the 215 operations. The estimated result of the number of users behind each IP address estimation operations 225 are available to the IP addresses exposed to campaign with view-through conversion determination operations 235. Using the information 220 in addition to the estimations of operations 225, the operations 235 may determine and output a single user-IP segment 240 (e.g., which includes all IP addresses having a single user that are exposed to an ad campaign with view-through conversions) and a multiple user-IP segment 245 (e.g., which includes all IP addresses having more than one user behind them that are exposed to an ad campaign with view-through conversions. The single user-IP segment information 240 and multiple user-IP segment 245 information may be obtained and used by the view-through conversion determination operations 250. Operations 250 may be used to determine the total number of view-through conversions for an ad campaign using such information. Data related to the ads, ad campaign, and advertiser may be stored in an advertising database 260 accessible to, for example, the operations 215 and 250.

IP address with conversion event determination operations 215 are responsible for analyzing the network and ad log information 210 in order to determine the IP addresses that have engaged in a conversion event. Specifically, the operations 215 may analyze such networks and ad logs as the ad query log, ad click log, and the advertiser's Weblog. These log sources may contain such information as IP address, landing page ID, ad campaign ID, timestamp, click time, conversion tracking ID, as well as other pertinent information. Therefore, the operations 215 may determine IP addresses that have engaged in a conversion event. These log sources may also be correlated to the advertising database 260, which includes specific ad campaign information such as ad campaign start date, end date, advertiser information, ad contents, ad group information (i.e. subsets of the ad campaign), and the like.

The number of users behind each IP address estimation operations 225 are responsible for determining the estimated number of users behind IP addresses and maintains an IP-user database 230. The 225 operations may accept IP addresses from the output 220 of the operations 215 and subsequently determine an estimated number of users behind the IP addresses. The 225 may do so by first examining the IP-user database 230 which may already include preprocessed information regarding number of users behind an IP address. If information is not available for an IP address, then the 225 operations may determine the number of users behind an IP address by examining cookies-IP associations as well as browser and user agent parameters. Such information may be obtained by the network and ad log information 210 amongst other log information. The '154 application describes exemplary techniques which may be used to determine the number of users behind an IP address.

The IP addresses exposed to a campaign with view-through conversion determination operations 235 are responsible for determining the IP addresses that have been exposed to an ad campaign and have engaged in a view-through conversion. Specifically, the 235 operations may obtain the output 220 of the operations 215 which are the IP addresses that have engaged in a conversion event. Subsequently, the operations 235 may determine whether these IP addresses that have engaged in a conversion event have also been exposed to an ad campaign. This is possible by using the network and ad log information 210 (or specifically the ad query log which may contain information per IP address regarding campaign ID, timestamp, Impression count, click time, etc.).

Once the operations 235 have all the IP addresses that have been exposed to a campaign and converted, the next step is to filter out all the click-through conversion so as to only keep the view-through conversions. The operations 235 may do so by again using the network and ad log information 210 (e.g., the ad query log and ad click log). The ad click log may contain information per IP address regarding campaign ID, timestamp, Impression count, click time, click count, etc. By comparing the ad query log and ad click log for each IP address, the operations 235 may filter out all the IP addresses with click-through conversions hence, crediting the rest of the IPs with view-through conversions.

Now the operations 235 have all the IP addresses exposed to a campaign with view-through conversions. As a final step, the operations 235 may use the operations 225 to segment the IP addresses into single user-IP segment 240 and multiple user-IP segment 245. The resultant single user-IP segment 240 and multiple user-IP segment may contain IP addresses, as well as their respective campaign exposure count or ad impression count. The ad impression count is used for determining the view-through conversion rate as will be explained below.

The view-through conversion determination operations 250 are responsible for obtaining the single user-IP segment results 240 from the 235 operations and determining the view-through conversions for the respective ad campaign. In particular, the view-through conversion determination operations 250 may determine a sample view-through conversion rate from the information contained in the single user-IP segment. The sample view-through conversion rate might simply be the number of conversions per thousand impressions for each ad campaign (and might be calculated by dividing the number of IP addresses in the single user-IP segment (i.e., number of conversions) by the number of impressions in the single user-IP segment (i.e., campaign exposure count/impression count), multiplied by a thousand). The result is a sample view-through conversion rate with units of view-through conversions per thousand impressions.

Subsequently, this sample view-through conversion rate may be multiplied by the total number of impressions derived from all IPs exposed to the campaign regardless of whether they converted or not. The final result is simply the number of view-through conversions for the campaign over the selected time conversion window (e.g., 30 days).

### Overview

At least some embodiments consistent with the present invention might estimate a total number of view-through conversions by (a) determining single-user IP addresses that had a view-through conversion for an advertisement of an advertiser to define a sample set of IP addresses, (b) determining a sample view-through conversion rate for the determined sample set of IP address, and (c) determining an estimated total number view-through conversions for the advertisement using the sample view-through conversion rate.

At least some embodiments consistent with the present invention might determine single-user IP addresses that had a view-through conversion for an advertisement to define a sample set of IP addresses by (a) determining a preliminary set of IP addresses that have both (i) had a conversion event on an advertiser Website and (ii) had been exposed to an advertisement of the advertiser before the conversion event, and (b) determining, from the determined preliminary set of IP addresses, only those IP addresses that have had a view-through conversion event to define a set of IP addresses, wherein the set of IP addresses includes all of the single-user IP addresses with a view-through conversion.

At least some embodiments consistent with the present invention might determine a sample view-through conversion rate for the determined sample set of IP address by (a) determining a number of single-user IP addresses that had a view-through conversion from the sample set of IP addresses, (b) determining an aggregate number of impressions from all single-user IP addresses that had a view-through conversion from the sample set of IP addresses, and (c) dividing the determined number of single-user IP addresses that have had a view-through conversion by the determined aggregate number of impressions from all single-user IP addresses that had a view-through conversion from the sample set of IP addresses to generate the sample view-through conversion rate.

Finally, at least some embodiments consistent with the present invention might determine an estimated total number of view-through conversions for the advertisement using the sample view-through conversion rate by (a) obtaining a total number of impressions of all IP addresses exposed to the advertisement of an advertiser, (b) obtaining the determined sample view-through conversion rate, and (c) multiplying the determined sample view-through conversion rate with the total number of impressions of all IP addresses exposed to the advertisement of an advertiser to generate the estimated total number of view-through conversions for the advertisement.

### §4.3.1 Exemplary Methods

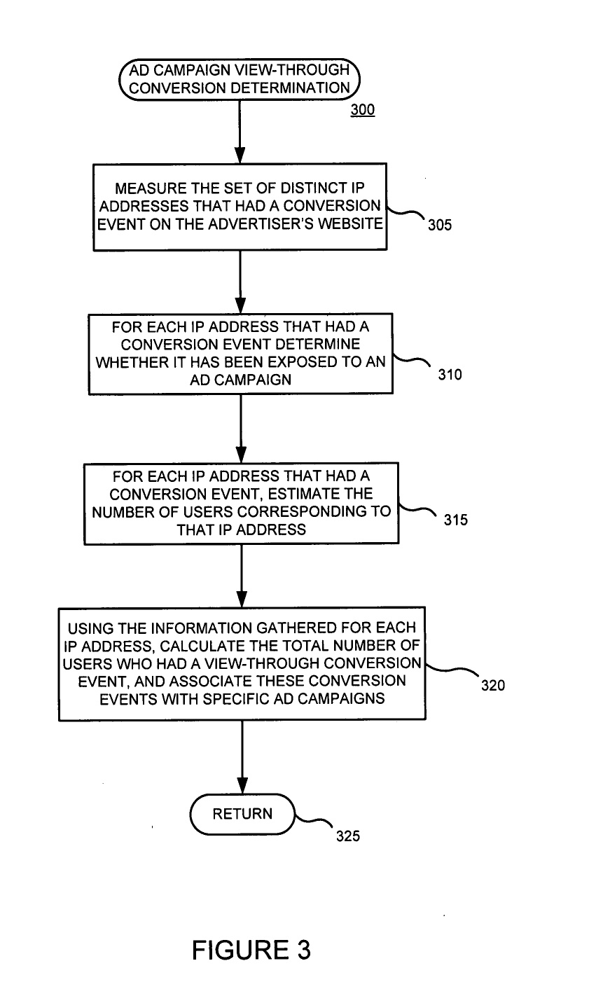

FIG. 3 is a flow diagram of an exemplary method 300 for determining the total number of view-through conversions that result from an advertising campaign in a manner consistent with the present invention. In particular, the method 300 may measure the set of distinct IP addresses that had a conversion event on the advertiser's Website. (Block 305) Subsequently, for each IP address that had a conversion event, the method 300 may determine whether it has been exposed to an ad campaign. (Block 310) Also, for each IP address that had a conversion event, the method 300 may estimate the number of users corresponding to that IP address. (Block 315) Finally, using the information gathered for each IP address, the method 300 may determine the total number of users who had a view-through conversion event as well as to associate these conversion events with specific campaigns. (Block 320)

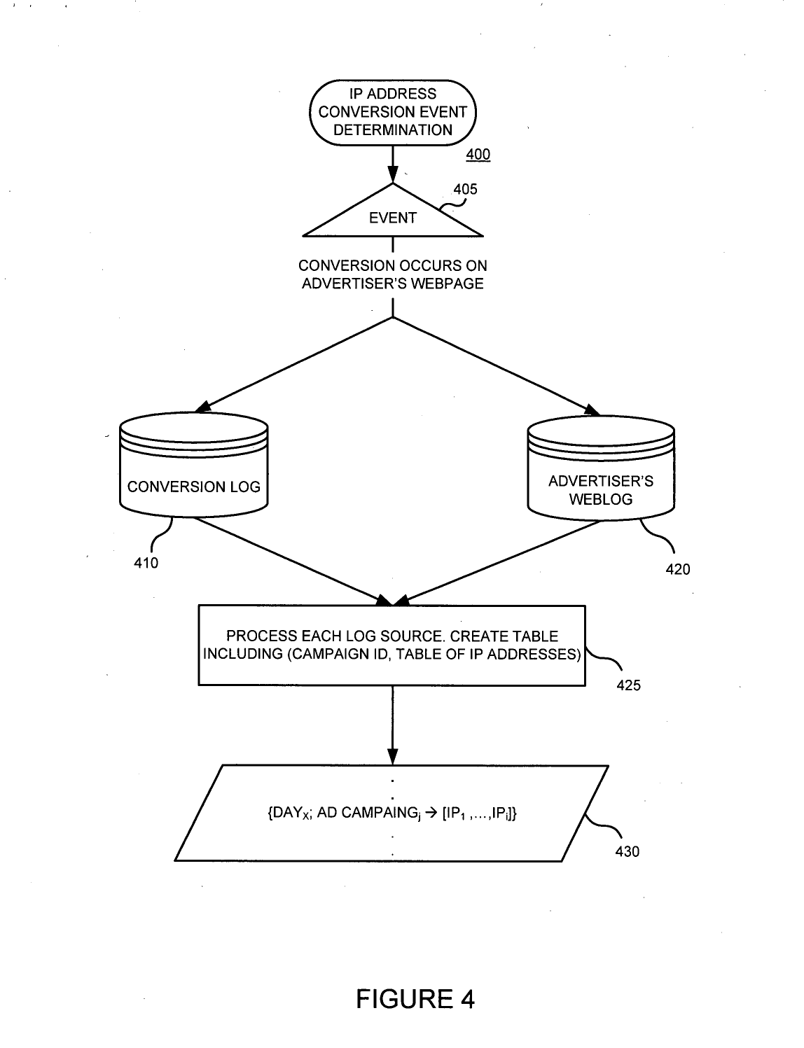

Referring back to block 305, FIG. 4 is a flow diagram of an exemplary method 400 for determining IP addresses that had a conversion event in a manner consistent with the present invention. Specifically, an event such as a conversion may occur on an advertiser's Webpage. (Block 405) Upon the occurrence of such an event, the method 400 may search various logs for information regarding the conversion event. (Logs 410 and 420) Next, the method 400 may process each log source and create a table including information such as: (campaign ID, table of IP addresses). (Block 425) After processing each log, the method 400 may output all the IP addresses involved in the conversion per day per ad campaign. Such information may be in the format of: {Dayₓ; Ad Campaignⱼ→[IP₁, . . . , IPᵢ]}. (Block 430)

Referring back to logs 410 and 420, exemplary sources of getting IP addresses that had a conversion event on the advertiser's Website include the following. View-through conversions may be tracked using conversion log information 410. For example, advertisers might be asked (or required) to place a light weight pixel on their Web pages that are relevant to conversion. When the page is fetched to trigger a conversion event, the pixel results in a redirect to the ad server (or some tracking server) and a conversion event including user's IP, time, etc. might be logged in the conversion log 410. Second, some analysis tools that track user behavior on Websites can provide log data (not shown) (e.g., as to which IP addresses have had a conversion event on a Website). Finally, some advertisers may provide their Web log 420 that contains IP addresses that visited their Websites and relevant Web pages (i.e., those that when visited, constitute a conversion).

Among these sources, view-through conversion tracking using light weight pixel advantageous since it is scalable and light weight. Certain logs might require advertisers to install some analysis tool software and therefore might not have comprehensive coverage. The least favorable approach is using an advertiser's web log because it might require advertisers to upload their logs to the tracking server. Furthermore, different advertisers might use different proprietary formats which might need to be parsed and normalized. Moreover some advertisers may not be willing to share their logs.

One exemplary approach would be to process each of the log sources to retrieve IP addresses with a conversion event (e.g., on a daily basis) and normalize the output into the format of IP addresses per customer (e.g., per day). We assume that for each landing page that is considered a conversion, there is a conversion tracking id associated with it. This is required for customers who want to track conversions.

Once the conversion events are logged, we could obtain IP addresses that are converted for each customer (advertiser) could be obtained. The data could then be partitioned by single-user IP segment and multi-user IP segment.

If the log source is advertising conversion log (conversion log 410) (with light weight pixel approach), a conversion event might contain data such as, IP address (the IP address that had a conversion on the advertiser's Website), conversion tracking id (for conversion tracking purposes, it is unique for each customer), and/or conversion tracking cookie (by checking the presence of conversion tracking cookie, whether the conversion is a result of early exposure and click on a campaign can be determined).

The conversion daily log 410 might be processed to produce one or more of the following for each IP address: (1) the customer id that it has converted (by looking up conversion tracking id to customer id mapping); (2) the number of transactions (visits on the conversion page), and (3) whether this IP has a single user or multiple users behind it, based on IP-user database input.

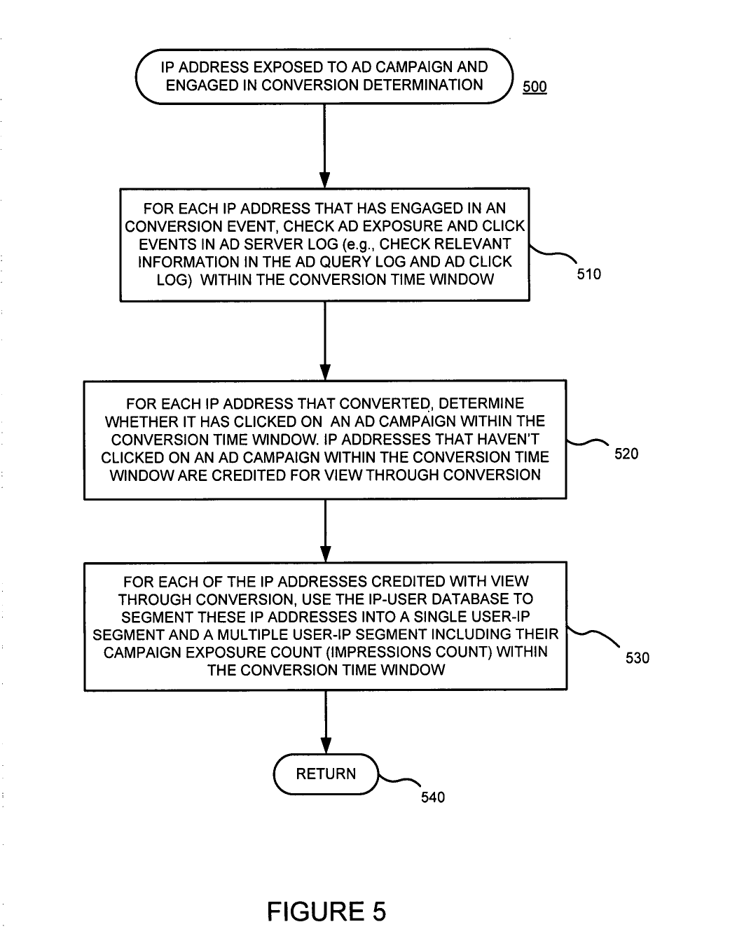

FIG. 5 is a flow diagram of an exemplary method 500 for determining IP addresses exposed to an ad campaign and engaged in a view-through conversion event in a manner consistent with the present invention. Specifically, for each IP address that has engaged in a conversion event, the method 500 may examine pertinent information regarding the IP addresses by checking ad exposure and selection events in one or more ad server logs (e.g., checking log(s) such as the ad query log and ad click log) within the conversion time window. (Block 510) By examining the ad query log and ad click log, the method 500 can determine, for each IP address that converted, whether it has clicked on an ad campaign within the conversion time window. The IP addresses that haven't clicked on an ad campaign within the conversion time window are credited for view-through conversion by the method 500. (Block 520) Next, for each of the IP addresses credited with view-through conversion(s), the method 500 may use the IP-user database to segment these IP addresses into a single user-IP segment and a multiple user-IP segment, each including their campaign exposure count (impressions count) within the conversion time window. (Block 530)

On the whole, for each single-user IP address that had a conversion event, the method 500 goes back to the Ad Query log over the view-through conversion time window (default 30 days), and determines whether it was exposed to a campaign, as well as the latest exposed campaign.

The method 500 might take into consideration the following factors when matching IPs for view-through conversions:

Click-through conversions might be excluded. That is, if a conversion event occurs as a result of click within the click-through conversion time window (currently 30 days), the conversion event might be excluded from view-through conversion matching.

Latest exposed campaigns might be credited for view-through conversions. That is, if a conversion event matches more than one impression event for the same advertiser, the campaign corresponding to the last exposure event might be credited with view-through conversion.

Given an ad campaign that has an associated data structure in an ad database including, for example, a campaign id, a campaign start date, a campaign end date, and a check date (day-S) (i.e., the date that is being checked), embodiments consistent with the present invention might determine the single-user IP addresses that have view-through conversions up to the day (to-date) as follows. First, get campaign start and end date from the ads database: start_date, end_date. Then, get daily single-user IP addresses that had a conversion event on the advertiser's site for the duration of [start_date, min(day-S, end_date+30)]. Note that the ending date might be chosen to be the earlier date of either day-S, or 30 days after the campaign has ended. This would allow the system to calculate the view-through conversion on an on-going basis if the campaign is still running, the 30 day conversion window is shorter than the duration of the ad campaign, and the ad campaign has not ended yet.

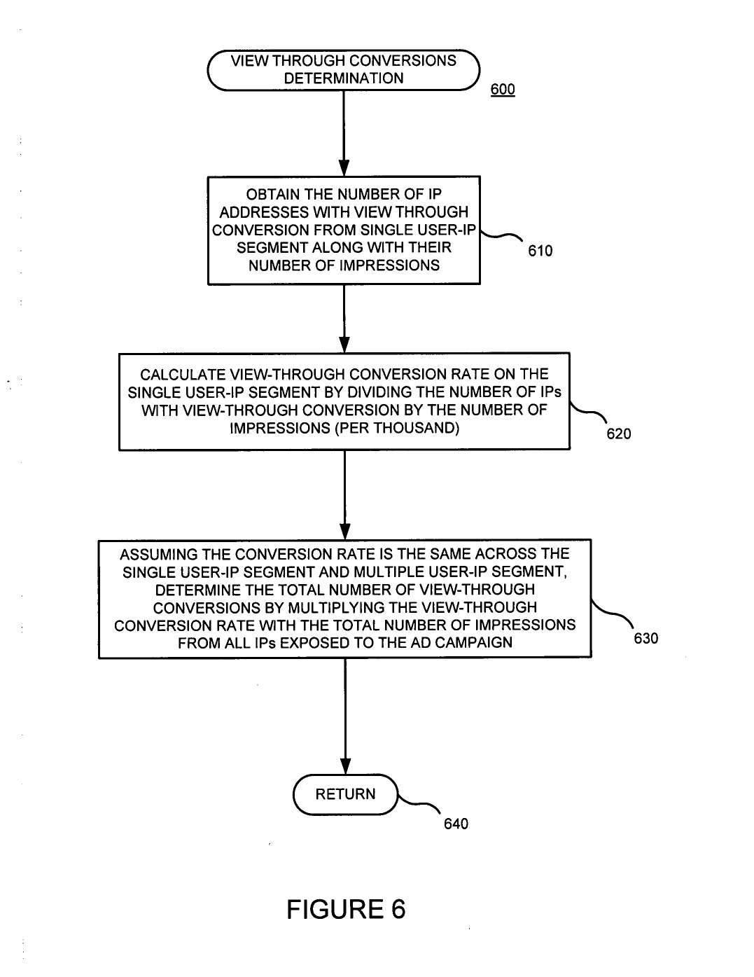

FIG. 6 is a flow diagram of an exemplary method 600 for determining the total number of view-through conversions that result from an advertising campaign in a manner consistent with the present invention. In particular, the method 600 may obtain the number of IP addresses with view-through conversion from the single user-IP segment along with their number of impressions. (Block 610) Next, the method 600 may calculate the (sample) view-through conversion rate on the single user-IP segment by dividing the number of IP addresses with view-through conversion by the number of impressions (per thousand). (Block 620) Finally, assuming the conversion rate is the same across the single user-IP segment and multiple user-IP, the method 600 may determine the total number of view-through conversions by multiplying the (sample) view-through conversion rate with the total number of impressions from all IPs exposed to the ad campaign. (Block 630)

Referring back to block 610, the method 600 may check against only IP addresses with a single user behind it to see whether it has viewed but not clicked on the campaign in the past (up to 30 day conversion window). The output of this act might be a table containing all single-user IPs that are exposed to the campaign (and number of times it is exposed to) for the duration: (ip_address, campaign exposure count, campaign exposure time) Still referring to block 610 daily, view-through conversions might be determined as follows.

For each day x in [start_date, min(day-S, end_date+30)], an ad log analysis is created and the output is merged for days in: [max(start_date, day x−30), day x] (i.e., go back to at most a 30 day conversion window (but not beyond campaign start date)). Then, for each IP address for day x (IP addresses that had a conversion on the advertiser's site), determine whether it is exposed to the campaign, but not clicked on it. Also, the latest exposed campaign is determined and credited for view-through conversion. This output might be aggregated over [start_date, min(day-S, end_date+30)]. The result is a set of single-user IPs that had view-through conversions during [start_date, min(day-S, end_date+30)]. This is the to-date view-through conversion numbers.

### §4.3.2 Exemplary Apparatus

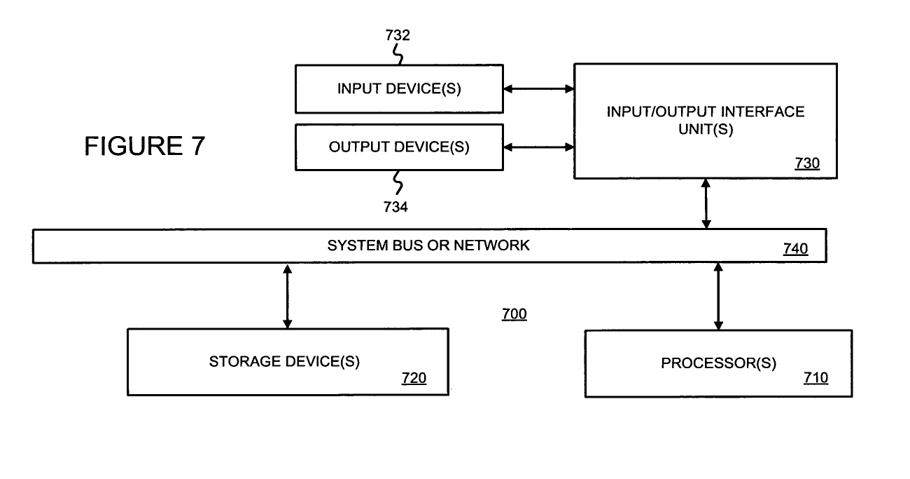

FIG. 7 is high-level block diagram of a machine 700 that may perform one or more of the operations discussed above. The machine 700 basically includes one or more processors 710, one or more input/output interface units 730, one or more storage devices 720, and one or more system buses and/or networks 740 for facilitating the communication of information among the coupled elements. One or more input devices 732 and one or more output devices 734 may be coupled with the one or more input/output interfaces 730.

The one or more processors 710 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 720 and/or may be received from an external source via one or more input interface units 730. Thus, the operations may be performed by the execution by the processor(s) 710 of machine-executable instructions (e.g., as modules), which may be stored on storage device(s) 720, and/or which may be received via input device(s) 732 and input/output interface unit(s) 730. Information generated and/or used by such operations may be stored on the storage device(s) 720 and/or sent to and/or received from an external device (not shown) via input/output interface unit(s) 730.

In one embodiment, the machine 700 may be one or more conventional personal computers. In this case, the processing units 710 may be one or more microprocessors. The bus 740 may include a system bus. The storage devices 720 may include system memory, such as read only memory (ROM) and/or random access memory (RAM). The storage devices 720 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 732, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 710 through an appropriate interface 730 coupled to the system bus 740. The output devices 734 may include a monitor or other type of display device, which may also be connected to the system bus 740 via an appropriate interface. In addition to (or instead of) the monitor, the personal computer may include other (peripheral) output devices (not shown), such as speakers and printers for example.

Referring back to FIG. 1, computers, ad servers and/or advertiser Websites might be implemented on one or more machines 700.

### §4.3.3 Refinements, Alternatives and Extensions

§4.3.3.1 View-Through Conversion Reporting

To provide daily/weekly/monthly/to-date reporting on view-through conversions, embodiments consistent with the present invention might run view-through conversion calculations as follows First, every day, calculate ‘to-date’ view-through conversions for campaigns that are: active, or ended but still within the view-through conversion time window (e.g. within 30 days past campaign end date). Then, every day, based on the ‘to-date’ view-through conversion number, calculate the daily/weekly/monthly view-through conversions for all ad campaigns. A script to query view-through conversion for ad campaigns based on campaign ID may be provided. Finally, a front end (UI) for users to submit view-through conversion requests based on campaign ID, and email the reports may be provided. Thus, view-through conversion data may be stored in any one of a number of alternative data structures (e.g., file, database, etc.), and reports can be generated by querying the data structure.

### §4.4 ILLUSTRATIVE EXAMPLE OF OPERATIONS OF AN EXEMPLARY EMBODIMENT CONSISTENT WITH THE PRESENT INVENTION

A simple example illustrating the above mentioned operation follows. First, assume an ad campaign (campaign_ABC) which has been exposed, according to network and ad logs, to 400 IP addresses with a total of 3000 impressions over a conversion time window of 30 days. Assume also that the method has determined that from the 400 IP addresses exposed to ad campaign_ABC, 180 of them have converted with a total of 2000 impressions. Further assume that from the 180 IP addresses exposed to the ad campaign_ABC and converted, 80 of them had view-through conversions with a total of 1200 impressions. From these 80 IP addresses, assume that 25 of them are single user IP addresses with a total of 400 impressions, while the other 55 of them are multiple user IP addresses with a total of 800 impressions.

Next, referring back to block 620 and assuming that the method 600 has obtained the single user-IP results mentioned above (specifically, 25 single user IPs with 400 impressions); the method 600 may calculate (sample) the view-through conversion rate as follows:

$$View\_through \_conversion \_rate = \frac{25 conversions}{400 impressions} \times 1000 = 62.5 \frac{view\_through \_conversions}{thousand\_impressions}$$

Subsequently, referring back to block 630, the method 600 may multiply this view-through conversion rate with the total number of impressions of the ad campaign_ABC within a 30 day conversion time window. In particular:

$$62.5 \frac{view\_through \_conversions}{thousand\_impressions} \times 3000 impressions = 187.5 view \text{-} through conversions .$$

Therefore, the method 600 has determined that within a conversion time window of 30 days, campaign_ABC has had 187.5 view-through conversions.

### §4.5 CONCLUSIONS

As can be appreciated from the foregoing, embodiments consistent with the present invention may be used to provide accurate view-through conversion information even in the absence of impression cookies.

1-43. (canceled)

44. A method for determining consumer response to an advertising campaign, the method comprising:
determining, by a processor, a first set of identifiers receiving impressions of the advertising campaign during a time window;
segmenting, by a processor, the first set of identifiers into a first segment of identifiers and a second segment of identifiers based on data indicative of a number of users associated with each of the first set of identifiers, wherein each identifier of the first segment of identifiers is associated with a single device and each identifier of the second segment of identifiers is associated with multiple devices;
determining, by a processor, a first number of impressions for the first segment of identifiers;
determining, by a processor, a second number of impressions for the second segment of identifiers;
determining, by a processor, a second set of identifiers, each associated with a view-through conversion during the time window, wherein the second set of identifiers are not associated with a click-through conversion;
determining, by a processor, a third set of identifiers by matching identifiers of the first segment of the first set of identifiers with identifiers of the second set of identifiers;
determining, by a processor, a sample view-through conversion rate for the time window based on a number of matched identifiers of the third set of identifiers and the first number of impressions for the first segment of identifiers;
calculating, by a processor, an estimate number of view-through conversions for the second segment of identifiers of the first set of identifiers based on the determined sample view-through conversion rate and the second number of impressions for the second segment of the first set of identifiers; and
calculating, by a processor, an estimate of a total number of view-through conversions for the advertising campaign during the time window based on the calculated estimate number of view-through conversions for the second segment of identifiers and a number of view-through conversions for the first segment of identifiers.

45. The computer-implemented method of claim 44, wherein the sample view-through conversion rate for the time window is based on a predetermined number of impressions.

46-49. (canceled)

50. The computer-implemented method of claim 44, further comprising:
determining, by a processor, a number of daily single-user view-through conversions for one or more dates.

51. The computer-implemented method of claim 44, further comprising:
determining, by a processor, a number of single-user view-through conversions for a single day.

52. A computer-implemented method for estimating a view-through conversion rate comprising:
determining, by a processor, a first set of Internet Protocol addresses including a single-user Internet Protocol address segment having Internet Protocol addresses each associated with a single device and a multi-user Internet Protocol address segment having Internet Protocol addresses each associated with multiple devices, each of the first set of Internet Protocol addresses having one or more impressions of an advertisement;
determining, by a processor, a first number of impressions for the single-user Internet Protocol address segment and a second number of impressions for the multi-user Internet Protocol address segment;
determining, by a processor, a second set of Internet Protocol addresses each associated with a view-through conversion, wherein the second set of Internet Protocol addresses are not associated with a click-through conversion;
determining, by a processor, a third set of the Internet Protocol addresses by matching Internet Protocol addresses of the single-user Internet Protocol address segment of the first set with Internet Protocol addresses of the second set;
determining, by a processor, a sample view-through conversion rate based on a number of matched Internet Protocol addresses of the third set and the first number of impressions for the single-user Internet Protocol address segment;
calculating, by a processor, an estimate number of view-through conversions for the multi-user Internet Protocol address segment based on the determined sample view-through conversion rate and the second number of impressions for the multi-user Internet Protocol address segment; and
calculating, by a processor, an estimate of a total number of view-through conversions for the advertisement based on the calculated estimate number of view-through conversions for the multi-user Internet Protocol address segment and a number of view-through conversions for the single-user Internet Protocol address segment.

53-56. (canceled)

57. Apparatus for determining consumer response to a set of one or more advertisements, the apparatus comprising:
a storage device including program instructions; and a processor for executing the program instructions, the program instructions, when executed by the processor, configuring the processor to:
determine a first set of identifiers receiving impressions of an advertisement during a time window;
segment the first set of identifiers into a single-user segment of identifiers and a multi-user segment of identifiers based on data indicative of a number of users associated with each of the first set of identifiers;
determine a first number of impressions for the single-user segment of identifiers and a second number of impressions for the multi-user segment of identifiers;
determine a second set of identifiers, each associated with a view-through conversion during the time window, wherein the second set of identifiers are not associated with a click-through conversion;
determine a third set of identifiers by matching identifiers of the single-user segment with identifiers of the second set;
determine a sample view-through conversion rate for the time window based on a number of matched identifiers of the third set and the first number of impressions for the single-user segment of identifiers;
calculate an estimate number of view-through conversions for the multi-user segment of identifiers based on the determined sample view-through conversion rate and the second number of impressions for the multi-user segment of identifiers; and
calculate an estimate of a total number of view-through conversions during the time window based on the calculated estimate number of view-through conversions for the multi-user segment of identifiers and a number of view-through conversions for the single-user segment of identifiers.

58-60. (canceled)

61. The apparatus of claim 57, wherein the sample single-user view-through conversion rate is based on a predetermined number of impressions.

62. (canceled)

63. The apparatus of claim 57, wherein the executed program instructions further configure the processor to:
determine a number of daily single-user view-through conversions for one or more dates.

64. The apparatus of claim 57, wherein the executed program instructions further configure the processor to:
determine a number of single-user view-through conversions for a single day.

65. A non-transitory computer-readable medium on which instructions of a program for estimating a view-through conversion rate for an advertisement are stored, the instructions, when executed by a processor, configuring the processor to:
determine a first set of Internet Protocol addresses including a single-user Internet Protocol address segment having Internet Protocol addresses each associated with a single device and a multi-user Internet Protocol address segment having Internet Protocol addresses each associated with multiple devices, each of the first set of Internet Protocol addresses having one or more impressions of the advertisement;
determine, by a processor, a first number of impressions for the single-user Internet Protocol address segment and a second number of impressions for the multi-user Internet Protocol address segment;
determine a second set of Internet Protocol addresses, each associated with a view-through conversion, wherein the second set of Internet Protocol addresses are not associated with a click-through conversion;
determine a third set of the Internet Protocol addresses by matching Internet Protocol addresses of the single-user Internet Protocol address segment with Internet Protocol addresses of the second set;
determine a sample view-through conversion rate based on a number of matched Internet Protocol addresses of the third set and the first number of impressions for the single-user Internet Protocol address segment;
calculate an estimate number of view-through conversions for the multi-user Internet Protocol address segment based on the determined sample view-through conversion rate and the second number of impressions for the multi-user Internet Protocol address segment; and
calculate an estimate of a total number of view-through conversions for the advertisement based on the calculated estimate number of view-through conversions for the multi-user Internet Protocol address segment and a number of view-through conversions for the single-user Internet Protocol address segment.

66-69. (canceled)

70. The method of claim 44, wherein determining the second set of identifiers each associated with a view-through conversion comprises filtering, from a set of total conversions, conversions associated with clicks.

71. The method of claim 44, wherein determining the second set of identifiers each associated with a view-through conversion comprises filtering, from a set of total conversions, conversions associated with clicks that occur within the time window.

72. The method of claim 44, wherein the second set of identifiers each associated with a view-through conversion excludes identifiers that view the advertisement, then click on the advertisement, then view the advertisement, and then complete a conversion within the time window.

73. The method of claim 44, wherein the second set of identifiers each associated with a view-through conversion excludes identifiers that click on the advertisement, then complete a first conversion, then view the advertisement, and then complete a second conversion within the time window.

74. The method of claim 44, wherein the second set of identifiers each associated with a view-through conversion includes identifiers that view the advertisement and completes a first conversion prior to clicking on the advertisement.

75-76. (canceled)

77. The computer-implemented method of claim 52, further comprising:
determining, by a processor, a number of view-through conversions for an ad group based, at least in part, on the estimated total number of view-through conversions for the advertisement.

78. The computer-implemented method of claim 52, further comprising:
determining, by a processor, a number of view-through conversions for an advertising campaign based, at least in part, on the estimated total number of view-through conversions for the advertisement.

79. The non-transitory computer-readable medium of claim 65, wherein the instructions, when executed by the processor, further configure the processor to:
determine a number of view-through conversions for an ad group based, at least in part, on the estimated total number of view-through conversions for the advertisement.

80. The non-transitory computer-readable medium of claim 65, wherein the instructions, when executed by the processor, further configure the processor to:
determine a number of view-through conversions for an advertising campaign based, at least in part, on the estimated total number of view-through conversions for the advertisement.
